(19) United States
(12) Patent Application Publication
(10) Pub. No.: US 2006/0203338 A1
(43) Pub. Date: Sep. 14, 2006

(54) System and method for dual stacked panel display

(75) Inventor: J. Larry Pezzaniti, Harvest, AL (US)

Correspondence Address: JAMES RICHARDS, 58 BONING RD, FAYETTEVILLE, TN, 37334, US

(73) Assignee: Polaris Sensor Technologies, Inc., Huntsville, AL (US)

(21) Appl. No.: 11/078,945

(22) Filed: Mar. 12, 2005

(51) Int. Cl. G02B 5/32; G02B 27/26

(52) U.S. Cl. 359/465; 359/15

(57) ABSTRACT

A system for display of three dimensional images and video utilizing flat panel technology, such as liquid crystal technology, wherein the left and right images are separated by polarization and the user wears polarized glasses to view the display. A first display, which may be any display technology, is used to generate an intensity modulated image. A second display is used to modulate the polarization of the intensity modulated image. A light spreading device is used to spread the light to minimize Moiré effects resulting from the use of two displays. In one embodiment, the light spreading device is a diffuser. In another embodiment, the light spreading device is a micro lens array.

### GOVERNMENT RIGHTS

The U.S. Government has a paid-up license in this invention and the right in limited circumstances to require the patent owner to license others on reasonable terms as provided for by the terms of contract W31P4Q-05-C-R117 awarded by U.S. Army Aviation and Missile Command, Redstone Arsenal, Huntsville Ala.

### BACKGROUND

1. Field of the Invention

The present invention pertains to the field of image display, more particularly to the field of stereoscopic three-dimensional image display.

2. Background of the Invention

Three-dimensional displays have proven valuable for a wide range of viewing needs including engineering design and modeling, viewing data in science and mathematics, architectural design, medical imaging, computer games, movies, and entertainment.

In addition, there are a growing number of scenarios where equipment and vehicles must be operated in environments unsafe for human presence. Some examples include explosive ordinance disposal, anti-personnel mine removal, tactical war fighting, chemical or biological strike reconnaissance, nuclear site inspection with high radioactivity, underground mines for excavation, orbital space, deep oceans, fire fighting locales, and many more. In these instances, it is preferable, if not necessary, to operate equipment from a remote location away from danger or the harmful environment. Still other scenarios involve manned vehicles where the driver must use a flat panel to see.

If a human operator performs a task in-situ, he receives feedback as a result of his manipulations, from visual, auditory, tactile, and force sensations. Of these feedback mechanisms, invariably the most important is visual. Ideally a remote vision system should mimic physical presence as much as possible. In addition to good fidelity, appropriate field of view and field of regard, etc., the vision system should support stereoscopic (3D) viewing in order to preserve depth of field information, and to ‘immerse’ the operator as much as possible in the scenario. For example, depth cues are essential if an operator is to safely negotiate a vehicle around obstacles, avoid negative surfaces, or control a robot arm to manipulate an explosive ordinance, or excavate a ground mine. A soldier operating a Tactical Unmanned Ground Vehicle is more effective if he is immersed in a 3D battlefield with both field of view and depth of field.

A stereographic display suitable for remote missions would ideally have the following characteristics: (1) high resolution, (2) good color, (3) brightness, (4) high contrast between left and right eye views, (5) no restriction on the number of people looking at one screen, (6) realistic stereoscopic images even at large viewing angles, and (7) no bulky head gear or eyewear that prevents seeing other things.

Polarization has been used in the past as a tool for separating left and right stereo images to generate a three-dimensional effect. One popular method that has been employed since the 1950's is a projection system which projects a stereo pair of orthogonally polarized images onto a polarization preserving screen. The stereo images are viewed through polarized glasses with the polarized glass for each eye oriented to receive the appropriate stereo image. Other techniques have been developed that involve polarization beam splitters and large box-like enclosures to separate the two stereo images. These techniques suffer from complicated optics, reduced resolution, reduced frame rate, bulky packaging, and other drawbacks that made them somewhat undesirable. The dual Liquid Crystal Display approach described by U.S. Pat. No. 6,181,303, uses two Liquid Crystal Display (LCD) panels (herein sometimes referred to as “panels”) stacked together to form a compact panel capable of displaying stereo images without loss of resolution or frame rate. The approach does require the user to wear polarization glasses similar to ones used in 3D movies. U.S. Pat. No. 6,181,303, issued Jan. 30, 2001 to Johnson et al. is hereby incorporated herein by reference.

The dual stacked liquid crystal three-dimensional display has a significant drawback. When the two panels are stacked together as described in U.S. Pat. No. 6,181,303, a Moiré fringe pattern is created. The Moiré pattern appears to the user as dark vertical bands that are superposed on the image. These bands are significant enough to interfere with the use of the display and limit the use of the display for many applications.

Therefore, there is a need for a stereographic display having the following characteristics: (1) high resolution, (2) good color, (3) brightness, (4) high contrast between left and right eye views, (5) no restriction on the number of people looking at one screen, (6) realistic stereoscopic images even at large viewing angles, and (7) no bulky head gear or eyewear that prevents seeing other things, and (8) no dark bands or other image artifacts that interfere with the use of the display.

### BRIEF DESCRIPTION OF THE INVENTION

Briefly, the present invention is a system and associated method for display of three dimensional images and video utilizing flat panel technology, such as liquid crystal technology, wherein the left and right images are separated by polarization and the user wears polarized glasses to view the display. Two stacked panels modulate light from a light source. The first panel is used to modulate the intensity of the light source. The second panel is used to modulate the polarization of the light source. A light spreader is used to spread the light to minimize Moiré effects resulting from the use of two stacked panels. In one embodiment, the light spreader is a diffuser. In another embodiment, the light spreader is a micro-lens array.

### BRIEF DESCRIPTION OF THE FIGURES

The present invention is described with reference to the accompanying drawings. In the drawings, like reference numbers indicate identical or functionally similar elements. Additionally, the left most digit(s) of a reference number identifies the drawing in which the reference number first appears.

FIG. 1 is a schematic diagram illustrating an exemplary embodiment of a three-dimensional display system in accordance with the present invention.

FIG. 2 shows the polarization state after passing through the second panel at an arbitrary pixel.

FIG. 3 (Prior Art) illustrates the origin of the dark bands due to Moiré type effects.

FIG. 4 shows an exemplary embodiment of the invention utilizing a diffuser to suppress Moiré artifacts.

FIG. 5 illustrates the angular dispersion characteristic for a holographic diffuser having a 10 degree 1/e full width Gaussian dispersion.

FIG. 6 illustrates the performance predicted for a stack of LCD panels including the diffuser of FIG. 5.

FIG. 7 shows measured performance of a LCD stack including a diffuser in accordance with the present invention.

FIG. 8 is a top cross section view of a section of dual stacked LCD panel utilizing a micro-lens array in accordance with the present invention.

### DETAILED DESCRIPTION OF THE PREFERRED EMBODIMENTS

Stereoscopic Display Background

The following is an overview of the technology as an aid in understanding the benefits of the present invention.

Wheatstone invented the first stereoscopic display on record in 1834. The stereoscope consisted of two mirrors mounted at 45-degree angles to each eye. The stereo images were placed such that when the viewer looked into the mirrors, the left eye saw the left image and the right eye saw only the right image. This invention represents the first known demonstration of an autostereoscopic display.

Stereoscopic displays can be divided into two basic categories—stereoscopic and autostereoscopic. Stereoscopic display systems require the viewer to wear some type of headgear in order to view the stereo pairs. Autostereoscopic systems do not require the viewer to wear special glasses. Each type of system has some inherent advantages and disadvantages.

One of the most well known stereoscopic display methods is based on time-multiplexing the stereo pairs on a conventional display. The left and right eye views of the scene are displayed on alternating fields or frames within the video signal. Some types of shutter glasses, worn by the observer, are used to insure that each eye only sees the appropriate scene. The glasses block light from reaching the right eye during the frame or field containing the left eye image and block light from reaching the left eye during the frame or field containing the right eye image. The stereo image perceived by the observer will appear to flicker if the switching rate is too slow. Typically the eye can detect flicker if the switching rate is less than 60 Hz leading to user fatigue and misperception. In any case, time-sequential multiplexing reduces the effective frame rate of the system by a factor of 2. Other commonly used methods requiring special glasses are color (red-blue) anaglyphs and polarization encoding techniques.

Autostereoscopic displays require more complicated optics to generate the illusion of depth. The fundamental approach is to design the optical system such that light from the left eye pixels only reaches the left eye and vice versa. The most common technique uses lenticular screens. A lenticular screen is normally a sheet of plastic cylindrical lenses oriented such that the long axis of the cylinder is parallel to the columns of the display. The left and right image pairs are displayed in alternating columns of the display and the lenticular screen focuses each eye on its corresponding image. The display is normally placed one focal length behind the lenticular array so that the image data is collimated as it exits. Similar approaches also use specially designed gratings to form a parallax barrier that allows each eye to see only the corresponding image. This approach, in general, reduces the horizontal resolution by a factor of 2. Autostereoscopic approaches also typically require tight tolerances on the placement of the observer's head to see the stereo pairs; this is known as the sweet spot.

A hybrid category has received some attention in the last few years. The proliferation of small, high-resolution displays has led some researchers to experiment with placing individual displays in front of each eye. This approach eliminates the reduced resolution and/or reduced frame rate associated with previous approaches. It does require the user to wear a complicated and somewhat bulky headset and interferes with normal viewing of the immediate environment. Also, in military vehicles, soldiers do not want to be connected to the vehicle with electrical cords associated with head gear in case of a need to exit the vehicle quickly.

3D Display Using Polarization

Polarization has been used in the past as a tool for separating left and right stereo pairs. Liquid Crystal Displays (LCD's) are also commonly used for stereoscopic displays. The techniques used previously, however, suffered from complicated optics, reduced resolution, reduced frame rate, bulky packaging, and other drawbacks that made them somewhat undesirable.

One approach uses polarization and LCD's but eliminates the need for complicated optics, reduced resolution and many other undesirable issues. Two LCD's are stacked together to form a compact panel capable of displaying stereo images without loss of resolution or frame rate. A left and right eye view of the sterographic scene is superposed on the first LCD. A second panel laid directly on top of the first panel encodes the left and right eye images into the polarization state of the light exiting the second overlaid LCD panel. The user wears polarization glasses having lenses of different polarization from eye to eye. The polarized lenses separate left from right views by passing light of the intended polarization and rejecting light of the other polarization. The two polarizations may ideally be orthogonal; however, completely orthogonal rotation is difficult to achieve. The system can produce 3D stereoscopic images or video with input from recorded stereo imagery or live imagery from two spatially separated cameras.

Stacked panels potentially generate Moiré artifacts exhibiting dark lines in the display that move as the observer's position moves. The Moiré artifacts may be reduced and essentially eliminated by placing a light spreader in the optical path. In one embodiment, the light spreader is a diffuser, preferably placed after the second panel. In another embodiment, the light spreader is a micro-lens array, preferably placed between the two panels.

3D LCD Display Architecture

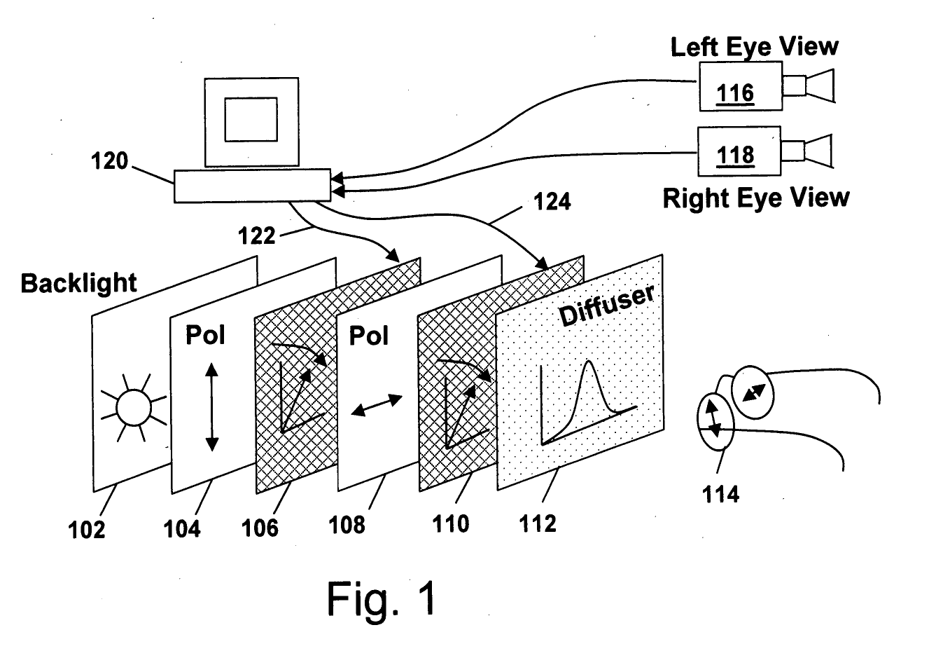

FIG. 1 is a schematic diagram illustrating an exemplary embodiment of a three-dimensional display system in accordance with the present invention. Referring to FIG. 1, the system comprises a dual LCD stack comprising a backlight 102, an input polarizer 104, a first LCD panel 106, an output polarizer 108 (also called an analyzer), a second LCD panel 110 and a diffuser 112. The user observes the panel through polarized glasses 114. The stereoscopic three-dimensional image is generated by a pair of cameras 116, 118, separated left and right to observe the left eye view 116 and the right eye view 118. The camera image outputs are then processed by an image processor 120 to generate drive signals 122, 124 for the two LCD panels 106, 110. The first LCD panel 106 operates in conjunction with the two polarizers 104, 108 to generate an image which is the sum of the two camera images, i.e. the intensity of a given pixel in the first LCD panel assembly (the assembly comprising 104, 106, 108) is the sum of the intensities of the corresponding pixels in each of the two cameras 116, 118. In the system depicted in FIG. 1, the first LCD panel 106 receives uniform polarized illumination and rotates the polarization of the illumination to achieve the desired resulting intensity as the light passes through the second polarizer 108. Thus, the output of the first panel assembly (including the polarizers) varies in intensity from pixel to pixel, but is uniformly polarized according to the second polarizer 108.

The second LCD panel 110 receives signals 124 from the image processor 120 that rotate the polarization of each pixel in accordance with the ratio of left and right intensity so that the appropriate fraction of light is received through each lens of the polarized glasses 114.

As shown in FIG. 1, the first LCD panel 106 may be of the twisted nematic type or other type that rotates polarized light according to the input drive level. The function of the first display (LCD panel assembly comprising 104,106,108), however is to modulate the intensity of the input light source from the backlight 102. Thus, other types of displays may be used for the first display, even such display types as other types of liquid crystals, plasma displays, or CRT's may be used, provided that the output is polarized for input to the second LCD panel 110. Thus an intensity display may be combined with a polarizer for the first display in the stack.

In one embodiment, two panels of identical design are used. For example, two Sharp LQ10D421 panels may be used. The Sharp LQ10D421 is a 10.4 inch (26.4 cm) diagonal panel with 640×480×3 pixels, with 3×640 RGB pixels arranged horizontally, i.e. the display comprises a repeating sequence red, green, and blue columns of pixels.

A backlight 102 is used to provide illumination for the display. The first panel 104 is placed on top of the backlight 102 in the normal configuration. Both the input and output polarizers 104, 108 remain on the LCD and it generates an intensity image as usual. A typical LCD panel may be shipped with input and output polarizers 104, 108 included. If present, the input and output polarizers are removed from the second panel prior to placing it on top of the stack. From bottom to top, the stack comprises a backlight 102, input polarizer 104, first liquid crystal panel 106, output polarizer 108, second liquid crystal panel 110, and diffuser 112.

Consider the two images captured by the ‘Left Eye’ 116 and ‘Right Eye’ 118 cameras. These two images must be displayed to the corresponding eyes of the observer in order for the observer to perceive depth. The first LCD 106 has both a polarizer and an analyzer and therefore yields an intensity image. The second panel 110 rotates the polarization of the incident light on a pixel-by-pixel basis but has no analyzer (output polarizer) to preferentially pass only one component of polarization. The information 124 sent to the second LCD is therefore encoded in polarization only. Combined with the polarizing glasses 114, this second panel 110 can be used to control the amount of light reaching the left and right eyes of the observer on a pixel-by-pixel basis. If the first panel 104 is used to produce the total intensity of the left and right image 116, 118, the second panel 110 can be used to control how much of that total intensity reaches each eye.

Mathematically, the process is described as follows:
I_{T}(x,y)=I_{L}(x,y)+I_{R}(x,y) (1)

where I_{L}(x,y) is the image intensity distribution captured by the ‘Left Eye’ camera 116, I_{R}(x,y) is the image intensity distribution captured by the ‘Right Eye’ camera 118, and I_{T}(x,y) is the total intensity in the resulting integrated image. In practice, the total intensity, I_{T}, must be divided by some value to account for the finite dynamic range of the system. Whereas, each individual camera image may modulate from full black to full white, the summed image should be adjusted to fit within the same full black to full white range available from the display.

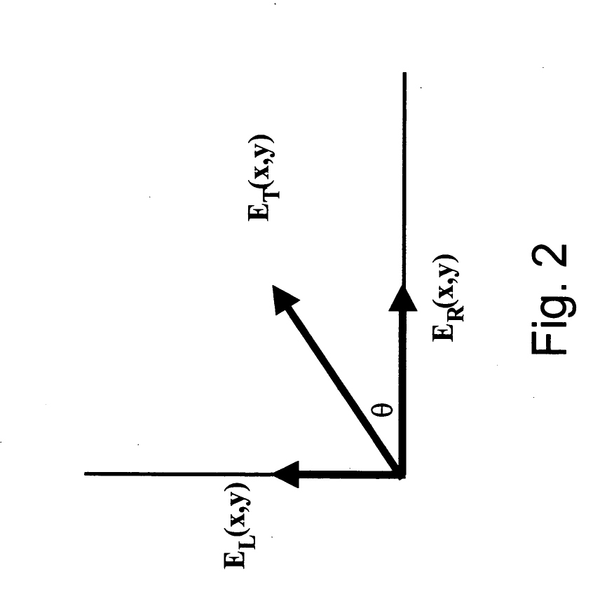

FIG. 2 shows the polarization state after passing through the second panel 110 at an arbitrary pixel. Referring to FIG. 2, the amplitude of the light leaving the first panel assembly 104, 106, 108 determines the length of the electric field vector. The orientation of that vector is determined by the amount of rotation imparted by the second panel 110. Superposition can be used to write the vector in terms of orthogonal polarizations referred to as E_{L}(x,y) and E_{R}(x,y). The polarizing glasses worn by the observer will now preferentially pass each of these two components to the appropriate eyes. Therefore, how the light is divided between the two eyes is determined by the orientation of the electric field vector leaving the second panel 110. Changing the orientation of the polarization vector changes the amount of light reaching each eye. In this manner, the light leaving the second panel 110 can be directed to the appropriate eye for the left and right stereo pairs.

Moiré Lines

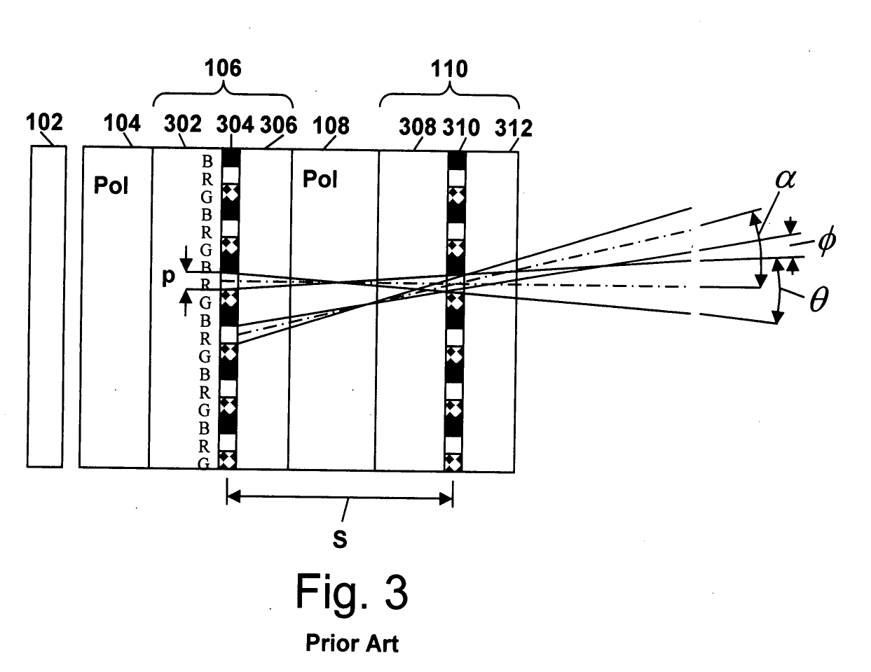

FIG. 3 illustrates the origin of the dark bands due to Moiré effects. FIG. 3 illustrates a top cross section view of the stack of FIG. 1 without the diffuser 112. FIG. 3 includes the backlight 102, the input polarizer 104, the first LCD panel, comprising input and output glass layers 302 and 306 and the LCD structures 304 (also referred to as the pixel plane 304), the output polarizer (analyzer) and the second LCD panel 110 comprising two glass layers 308, 312 and the LCD structures 310 (also referred to herein as the pixel plane 310).

The light from the backlight 102 enters the first LCD panel 106 from the left. The light is transmitted through the first LCD panel 106, the output polarizer 108 and the second LCD panel 110. The viewer's eyes focus on the second LCD panel 110. The figure illustrates the light paths for the red pixels, but of course this may be generalized for the green and blue pixels as well.

If the line of sight of the viewer's eye is aligned along one of the dashed lines shown, the light transmitted through both pixels in the first panel 106 and the second panel 110 will enter the viewer's pupil and the viewer will see a bright presentation of the image. If the viewer's line of sight is between these dashed lines, then the viewer will see a dark band. This is because the viewer will be viewing only blue or green pixels in the first panel 106 through the red pixel in the second panel 110. Since the green pixel (or blue) removes all but green (or blue) light and the red pixel removes all but red light, no light should go through both pixels, resulting in a dark band. The angular extent θ of a bright band is defined by the rim rays as shown and is given by

$$θ = 2 \cdot n \cdot \frac{p}{S} \qquad ( 1 )$$

where p is the pitch of the pixel, n is the refractive index of the LCD panel glass and polarizer, and S is the distance between the pixel plane in the first LCD panel 106 and the second LCD panel 110 as shown in FIG. 3. The separation between the bright bands is given by

$$α = 3 \cdot n \cdot \frac{p}{S} \qquad ( 2 )$$

Therefore the dark band between the bright bands is given by

$$ϕ = α - θ = n \cdot \frac{p}{S} \qquad ( 3 )$$

Suppose that the display has the following parameters as shown in Table 1:

TABLE 1

| Parameter | Dimension | |
|---|---|---|
| n | 1.55 | |
| P | 0.11 | mm |
| S | 1.58 | mm |
| LCD glass thickness | 0.7 | mm |
| Polarizer thickness | 1 | mm |

Then from equations (1) and (2) θ=8.14 degrees, α=12.21 deg. Note that α is larger than θ, therefore there appears the dark band between the bright bands. Here we will define ξ as the ratio between θ and α,

$$ξ = \frac{θ}{α} \qquad ( 4 )$$

For the parameters given in the above Table 1, ξ=0.67. In order to eliminate the dark band, the angular separation between the bright bands has to be less than the spread of the bright bands, i.e. ξ>1.

Note that ξ is independent of the thickness of the LCD panels 106, 110 and the polarizer 108. Thus, by moving the LCD panel pixel planes closer together, the dark line spacing can be increased, but the dark line is not eliminated.

Dark Line Suppression Using a Diffuser

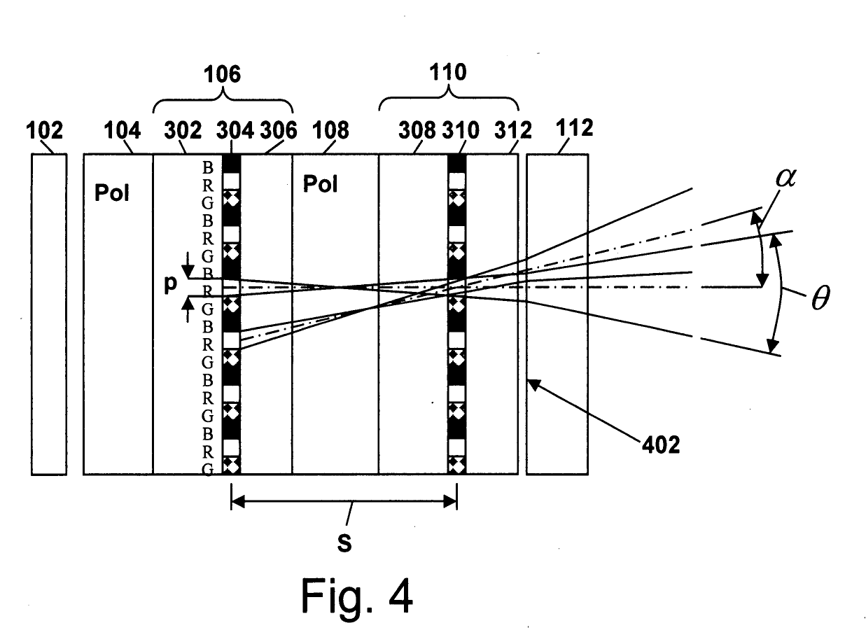

Moiré artifacts may be suppressed by using a diffuser 112. The diffuser 112 is preferably placed after the second LCD panel 110 as shown in FIG. 4 and as close to the second LCD panel 110 as practical. FIG. 4 shows an exemplary embodiment of the invention utilizing a diffuser 112 to suppress Moiré artifacts. Referring to FIG. 4, the stack comprises a backlight 102, a first LCD panel 106, two polarizers 104, 108, a second LCD panel 110, and a diffuser 112. The first LCD panel assembly comprises an input polarizer 104, an LCD structure 304 sandwiched between a first glass 302 and a second glass 306, and an output polarizer 108. The output polarizer 108 may also be called an analyzer.

The function of the diffuser is to convert unidirectional light into a diffuse pattern. Several types of diffusers can be used for this purpose, including, but not limited to, holographic, diffractive, gray scale diffractive, binary diffractive, asynchronous grating diffractive and others. The light diffusion may typically result from surface effects, but can result from bulk transmission effects. In the embodiment shown in FIG. 4, a surface diffuser 112 with the diffusing surface 404 on the inside of diffuser substrate 112 places the diffuser as close to the display as is practical without modifying the LCD panel 110.

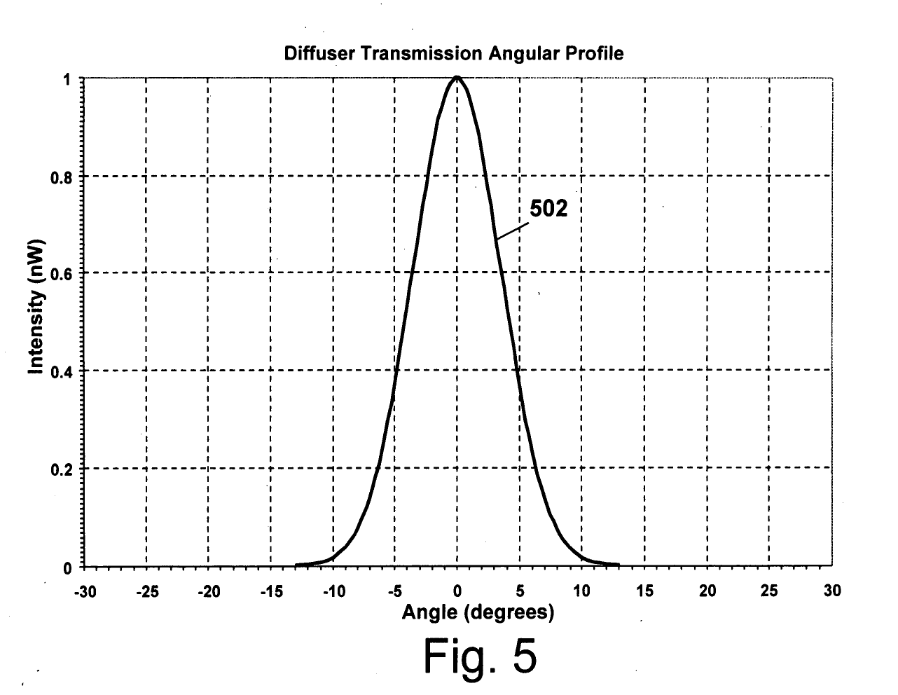

FIG. 5 illustrates the angular dispersion characteristic 502 for a holographic diffuser 112 having a 10 degree 1/e full width Gaussian dispersion. Other diffuser profiles and other dispersion widths may be used, depending on the display configuration.

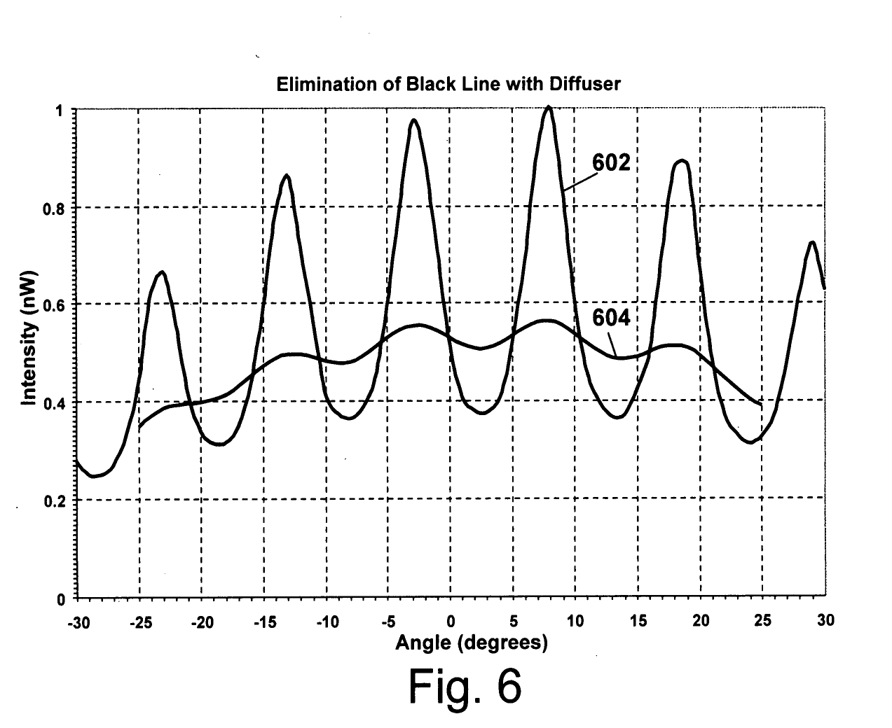

FIG. 6 illustrates the performance predicted for a stack of LCD panels including the diffuser of FIG. 5. Referring to FIG. 6, Curve 602 shows the predicted performance of the stack without the diffuser 112. Curve 604 shows the predicted performance with the diffuser 112. The angular separation between the dark bands is approximately 12 degrees. FIG. 6 curve 604 illustrates the reduced amplitude Moiré fringe pattern observed when the angular distribution of the diffuser 112 from FIG. 5 is convolved with the angular distribution of the intensity transmitted through the second panel 110 shown in FIG. 6 curve 602. When the light from the display passes through the diffuser 112, some of the light that would normally be directed into the bright bands is redirected by the diffuser into the dark band—and vice versa. The effect is that the angular distribution of the light exiting the display is convolved with the angular transmission of the holographic diffuser and the amplitude of the dark band modulation is dramatically reduced.

The spreading of the light is traded between the desirability for spreading the light across several pixels (from red, across blue and green to red again) with the undesirability of blurring the image and reducing pixel crispness. By placing the diffuser 112 close to the pixel plane of the second display 310 and relatively more distant from the pixel plane of the first display 304, blurring of the second display 310 is minimized and light is spread across the dark bands (alternate color pixels) of the first display 304.

In a typical display, the colors may be arranged in vertical stripes as shown in FIG. 4. Thus, the diffuser may be designed to spread light horizontally without spreading vertically, or to spread more horizontally than vertically.

In one embodiment, the diffuser response is designed to flatten the intensity modulation curve 602 so that the resulting curve 604 is as flat as practical. In one embodiment the diffuser function 502 may have a Gaussian shape as shown in FIG. 5 or may have a substantially triangular shape or rectangular shape or may be generated having a spectral properties complementary to the intensity modulation curve 602. The spreading function may also be designed to spread light horizontally with minimal spreading vertically. To determine the optimal diffuser for reducing intensity modulation for a particular dual panel set, the the diffuser angular spread function can be convolved with the angular dependence of the dual panel intensity modulation function 604. The result of this calculation will be the expected modified intensity modulation after the diffuser. Note that the diffuser does not necessary have to spread the light in the vertical plane as the fringes only occur in the horizontal direction (provided the color filters change in the horizontal direction).

The final design trades may include panel brightness, contrast, sharpness, tolerance of the user for dark bands, and other factors. These factors may be traded and optimized for a given application and user base using such design packages as ZEMAX or Code V or others.

Thus, the diffuser essentially eliminates the Moiré bands from the display, enabling the use of the stacked dual LCD stereoscopic three-dimensional display in applications where the Moiré pattern would otherwise be objectionable and render the display unsuitable.

Measured Performance

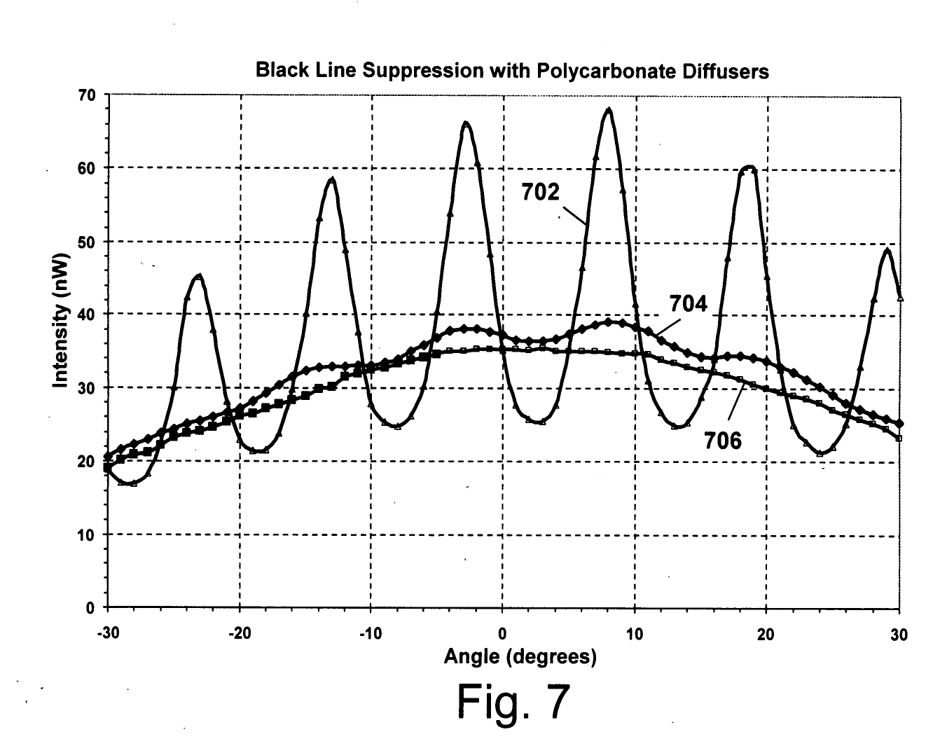

FIG. 7 shows measured performance of a LCD stack including a diffuser in accordance with the present invention. Referring to FIG. 7, curve 702 shows measurements of the Moiré fringe pattern with no diffuser 112 in place, Curve 704 shows the reduced amplitude Moiré fringe pattern when a diffuser 112 with a 10 degree diffuser pattern (see FIG. 5) is placed after the second panel 110. Curve 706 shows the further reduced amplitude of the Moiré fringe pattern when a diffuser 112 with a 15 degree diffuser pattern is placed after the second panel 110. Comparison of FIG. 6 and FIG. 7 shows that the measurements confirm the expected results.

The diffuser 112 can have the appearance of ground glass. When an object is viewed through ground glass the object appears “blurry”. As the object moves closer and closer to the ground glass the object becomes clearer and clearer. This is because when the light is diffused in close proximity to the object plane then object fidelity is minimally affected. Therefore, the diffuser 112 may be placed in close proximity to the pixel plane of the LCD display for best screen fidelity. For example, with a 10 degree diffuser 112 placed 2-3 mm in front of the pixel plane 310, no apparent change in the crispness of pictures or text may be detected. In one embodiment, the diffuser 112 may be fabricated as a part of the second display device, for example, fabricated on one surface of the LCD glass 312.

The diffusers 112 (holographic, diffractive or other) do not change the color or the color trueness of the display. This is because the light exiting the second panel 110 is transmitted in random direction within the banded envelopes of the Moiré fringe pattern. The color dispersion introduced by the structure of the diffuser 112 is therefore washed out by the random direction of the light exiting the LCD stack. The dark lines of the Moiré pattern are therefore suppressed without reducing the crispness, or color of the images or text.

Care should be taken in selecting the substrate for the diffuser 112. The diffuser 112 should preferably not change the polarization state of the image because the stereo image is encoded in polarization. Several glass and plastic substrates are available that are non-birefringent or very low birefringent. Most glasses, if annealed properly, are non-birefringent. Acrylic can be a very low to non-birefringent material, although other plastics are possible depending on the manufacturing process.

Alternatively, the diffuser 112 can be placed between the panels 106 and 110, but with slight loss in optical intensity of the display assembly.

Dark Line Suppression Using a Micro Lens Array

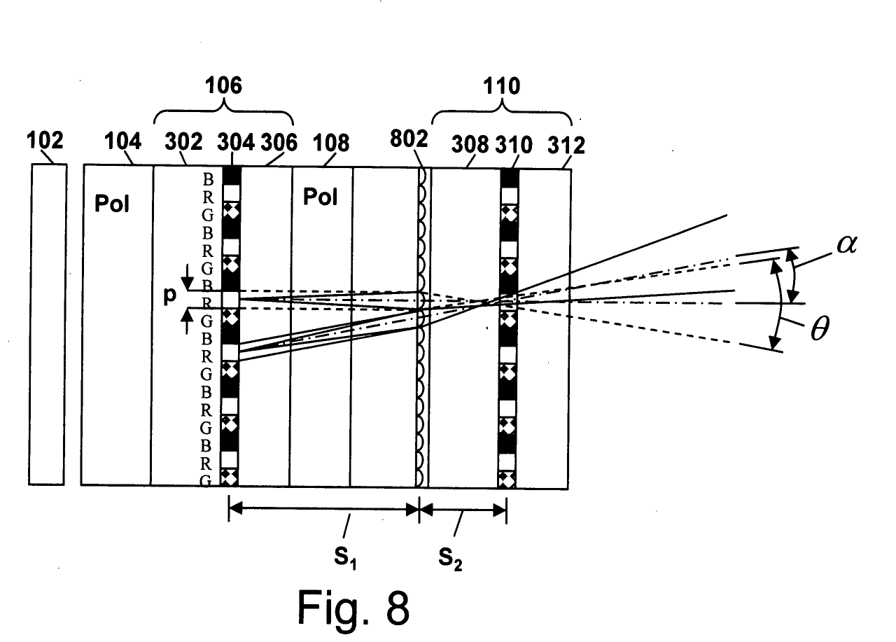

FIG. 8 is an exemplary top cross section view of a section of dual stacked LCD panel utilizing a micro-lens array in accordance with the present invention. Referring to FIG. 8, FIG. 8 shows the dual LCD display with a micro-lens array 802 between the LCD panels. The micro-lens array 802 may be an array of cylindrical lenses. The cylindrical lenses 802 image the pixels apertures of the first panel 106 onto the pixel apertures of the second panel 110. Ray tracing is shown for the imaging of pixel plane 304 onto pixel plane 310. Dotted lines show the rim rays from the upper red pixel being spread to an angle θ. Solid lines show the rim rays from the lower red pixel, also spreading to an angle θ. Dash-dot lines show the center line of each pixel spread pattern. The angular separation of the center lines is α. Note that, after spreading, θ is greater than α and the spreading patterns for the two red pixels overlap.

The angular spread of the light exiting the second panel 110, θ that is transmitted through the first panel 106 pixel, then re-imaged onto the second panel 110 is given by

$$θ = n \cdot p \cdot ( \frac{1}{{S}_{1}} + \frac{1}{{S}_{2}} ) = n \cdot \frac{p}{f} = \frac{n}{f \#} \qquad ( 5 )$$

where f is the focal length of the micro lens 108 and the other parameters are as defined earlier. The angular separation of the bright bands is given by

$$α = n \cdot \frac{p}{{S}_{2}} \qquad ( 6 )$$

Suppose that the display has the following parameters as shown in Table 2:

TABLE 2

| Parameter | Dimension | |
|---|---|---|
| n | 1.55 | |
| P | 0.11 | mm |
| S₁ | 1.58 | mm |
| LCD glass thickness | 0.7 | mm |
| Polarizer thickness | .25 | mm |

Then from equations (5) and (6), θ=18.03 degrees, α=13.96 deg. Note that α is now smaller than θ, therefore the bright bands overlap and the dark band disappears. For these parameters, ξ=1.42. Thus when the micro lens array 802 is placed between the first panel 106 and the second panel 110 such that the first panel pixels are imaged onto second panel pixels, the divergence of each pixel in the second panel 110 is greater than the angular separation of the dark bands, and the dark bands are “washed out”.

The micro lens array 802 can be a refractive lens, with a quadratic, aspheric or any other shape that generates optical power. In one embodiment, the micro lens array 802 may be cylindrical to take advantage of the columnar arrangement of pixels in the panels 106, 110. It can also be a diffractive, holographic or any other surface profile that generates optical power. The micro lens surface can be formed on the surface of a separate layer as shown in FIG. 8, or on any other surface between the pixel plane 304 of the first panel 106 and the pixel plane 310 of the second panel 110. For example, it can be formed on the LCD cover glass 308, (i.e., made part of the LCD cover glass 308), or the polarizer surface 108 or the first surface of the micro lens panel 802. Alternatively, the optical power required for the micro lens array 802 can be distributed among several or all surfaces between the pixel planes of the first panel 106 and the second panel 110.

The pixel plane of the first panel 106 does not have to be imaged exactly onto the pixel plane of the second panel 110. The pixels of the first panel 106 may be defocused with respect to the pixel plane of the second panel 110, focused beyond the pixel plane of the second panel 110 or before the pixel plane of the second panel 110.

Because the micro lens array images the first pixel plane 304 onto the second 310, the resulting panel brightness may be enhanced compared to a diffuser embodiment.

Alternatively, the micro lens array 802 may be placed after the second panel 110. When placed after the second panel 110, the micro-lens array acts much like the diffuser 112.

The final design trades may include panel brightness, contrast, sharpness, tolerance of the user for dark bands, and other factors. These factors may be traded and optimized for a given application and user base using such design packages as ZEMAX or Code V or others.

Linearity Correction

The second panel 110 operates with a particular input linear polarization state from the second polarizer 108 and outputs two nearly orthogonal analyzed polarization states on the polarized glasses. These states may or may not be the optimal polarization states. The Mueller matrix of the LCD panel 110 may be characterized in order to determine the best input and analyzed polarization states. Measurements may be made at different wavelengths and gain settings. Once the panel is characterized, compensation may be designed and implemented in the video processor 120.

Anti-Reflective (AR) Coat to Eliminate Glare on Display

Glare can be an issue with any display. Glare is caused by ambient light reflecting off the glass to air interface surface(s) of the LCD display stack. One of the solutions to eliminate or minimize glare on a LCD flat panel display is to have a slightly rough surface as the last surface of the display. A slightly rough surface will diffuse a specular reflection. The diffuser 112 used to spread the light in the present invention may serve to reduce glare to an acceptable level.

In one embodiment, the diffuser may be fabricated on the output surface of the second LCD panel. The diffuser 112 may be fabricated on the output surface of the LCD stack or may be placed before the output surface. If placed before the output surface of the stack, the diffuser 112 will not help with glare from the output surface. Thus, in one embodiment, the diffuser 112 may include a diffusing surface on the inside surface of the diffuser element 112 with the outside surface of the diffuser element 112 having an AR coating to reduce glare.

In an alternative embodiment, the diffuser 112 is a thin non-birefringent film adhesively attached to the output glass 312 on the second panel 110.

If the diffuser 112 is not incuded or not sufficient to eliminate glare, then other methods are available. One choice utilizes moth-eye structures. These structures function as an antireflection surface; reducing reflections to <1% over the entire visible spectrum and over broad angle of incidence range. The moth-eye structure has just currently become commercially available on thin film plastic substrates. Further information on moth-eye structures may be found in U.S. Pat. No. 6,388,372, issued May 14, 2002 to Raj et al., which is incorporated herein by reference.

Antireflection (AR) coatings are also available on both glass and plastic. An AR coating works very well to eliminate glare.

Optimization of Polarization States

Ideally, the LCD panel can rotate the polarization between zero and 90 degrees with a linear transfer function relating drive voltage and rotation angle. Also, the polarization state should be linear optical polarization (no ellipticity). However, realistic panels may have limited rotation range, for example 70 degrees, may have a nonlinear transfer function, and may include elliptical polarization states. The first step in correcting for panel imperfections is to thoroughly characterize the panel.

The measurements would be made as follows. First, the polarization modulation characteristics of the liquid crystal panels could be measured. This may be done using polarization metrology techniques such as the Mueller matrix spectro-polarimeter. Alternatively, techniques using Stokes polarimeters may be used. The retardance magnitude, retardance orientation, retardance ellipticity as well as diattenuation can be measured as a function of applied voltage, wavelength and incident angle, as well as other parameters as deemed necessary. The retardance (magnitude, orientation and ellipticity) data can be used to find the optimal polarization states for operating the LCD.

By knowing the full Mueller matrix, the ideal operating polarization states of the LCD may be found and compensation may then be designed to optimize performance. It may be possible that, for some LCD panels, the optimal polarization states are elliptical, not linear. Elliptical states may be utilized by including retarder films in conjunction with the polarizer films. The use of elliptical polarization states may allow a significant increase in polarization modulation, which could lead to an increase in the contrast between left and right eye views. The encoding algorithm would then be optimized for the actual modulation curve of the liquid crystal panels.

### CONCLUSION

While particular embodiments of the invention have been described, it will be understood, however, that the invention is not limited thereto, since modifications may be made by those skilled in the art, particularly in light of the foregoing teachings. It is, therefore contemplated by the appended claims to cover any such modifications that incorporate those features or those improvements which embody the spirit and scope of the present invention.

1-20. (canceled)

21. A system for displaying a three dimensional image, said system comprising:
a first display, said first display producing intensity modulated illumination in accordance with said three dimensional image;
a second display, said second display modulating the polarization of said intensity modulated illumination in accordance with said three dimensional image, said first display and said second display generating a Moiré fringe pattern; and
a light spreading device, said light spreading device spreading said intensity modulated illumination.

22. The system of claim 21, wherein the first display comprises a liquid crystal display panel.

23. The system of claim 21, wherein the light spreading device comprises a diffuser.

24. The system of claim 23, wherein the diffuser is disposed between the second display and polarized glasses to be worn by a viewer.

25. The system of claim 23, wherein the diffuser is a part of the second display.

26. The system of claim 23, wherein the diffuser has a diffusing surface, and the diffusing surface of the diffuser is spaced within 3 millimeters from the second display.

27. The system of claim 23, wherein the diffuser spreading characteristic is substantially Gaussian.

28. The system of claim 23, wherein the diffuser has an effective amount of spreading to reduce said Moiré fringe pattern to an acceptable level.

29. The system of claim 28, wherein the diffuser has a spreading characteristic at least 5 degrees 1/e full width.

30. The system of claim 29, wherein the diffuser has a spreading characteristic having a 1/e full width value equal to at least half of the spacing between two adjacent peaks of said Moiré fringe pattern.

31. The system of claim 23, wherein the first display, second display and diffuser comprise a stack, said stack having an output surface, and wherein the diffuser is disposed between the first display the output surface of the stack.

32. The system of claim 23, wherein the first display, second display and diffuser comprise a stack, said stack having an output surface, and wherein the diffuser includes the output surface of the stack.

33. The system of claim 23, wherein the diffuser is holographic or diffractive.

34. The system of claim 33, wherein the diffuser is grey scale diffractive, binary diffractive, or asynchronous grating diffractive.

35. The system of claim 23, wherein the diffuser comprises a thin film adhesively attached to at least one surface of the second display.

36. The system of claim 21, wherein the light spreading device is a micro-lens array.

37. The system of claim 36, wherein the first display and second display each have a respective pixel plane; and wherein the micro-lens array is disposed between the pixel plane of the first display and the pixel plane of the second display.

38. The system of claim 37, wherein the micro-lens array images the pixel plane of the first display to a plane near the pixel plane of the second display.

39. The system of claim 36, wherein the micro-lens array comprises a cylindrical lens.

40. The system of claim 36, wherein the shape of at least one lens of the micro-lens array is quadratic, circular, spherical, aspheric, or holographic.

41. The system of claim 36, wherein the micro-lens array is a part of said first display or said second display.

42. A method for displaying a three dimensional image using a display assembly, said display assembly comprising a first display and a second display, said method comprising the steps:
generating a first image using said first display;
modifying said first image using said second display; and
spreading the light from said first image.

43. The method of claim 42, wherein the spreading is accomplished before the output surface of said display assembly.

44. The method of claim 42, wherein the spreading is accomplished after said light passes through said second display.

45. The method of claim 42, wherein the spreading step includes the step of:
diffusing said intensity modulated illumination.

46. The method of claim 42, wherein the spreading step includes the step of:
imaging said intensity modulated illumination.

47. The method of claim 42, wherein the display assembly, without the spreading step produces at least one Moiré fringe at an unacceptable level, and wherein the spreading is sufficient to reduce said at least one Moiré fringe to an acceptable level.

48. A stereo three dimensional image display comprising:
a first display; said first display for presenting an intensity modulated image based on said stereo image;
a second display for modulating the polarization of the intensity modulated image, said modulation based on said stereo image; and
a light spreading layer, said light spreading layer for spreading the light from the first display to reduce intensity variations resulting from Moiré effects;
wherein said first display, said second display and said light spreading layer are stacked sequentially so that light from said first display passes through, in any order, said second display and said light spreading layer.
